(19) United States
(12) Patent Application Publication
(10) Pub. No.: US 2025/0180177 A1
(43) Pub. Date: Jun. 5, 2025

(54) Interchangeable Decorative Light String System

(71) Applicants: Matthew Roznovsky, New Braunfels, TX (US); Robert Sparks, New Braunfels, TX (US); Lacy Roznovsky, New Braunfels, TX (US)

(72) Inventors: Matthew Roznovsky, New Braunfels, TX (US); Robert Sparks, New Braunfels, TX (US); Lacy Roznovsky, New Braunfels, TX (US)

(21) Appl. No.: 18/911,241

(22) Filed: Oct. 10, 2024

Related U.S. Application Data
(60) Provisional application No. 63/543,337, filed on Oct. 10, 2023.

(51) Int. Cl. F21S 4/10; F21V 23/00; F21V 23/02; F21V 23/06; F21V 31/00; F21Y 103/10; F21Y 113/13; F21Y 115/10; H05B 47/19

(52) U.S. Cl. CPC F21S 4/10; F21V 23/003; F21V 23/02; F21V 23/06; F21V 31/00; H05B 47/19; F21Y 2103/10; F21Y 2113/13; F21Y 2115/10

(57) ABSTRACT

Aspects of the lighting include a novel interchangeable decorative light string system. The system is a customizable, flexible, and energy efficient decorative lighting solution.

### RELATED APPLICATION

This application is an International Application claiming priority to U.S. Provisional Patent Application 63/543,337 filed Oct. 10, 2023, which is incorporated herein by reference in its entirety.

### FIELD

The present invention relates to the field of decorative light strings, specifically to a novel design of decorative light strings with interchangeable elements, power-efficient capabilities, and accessories for customizable configurations.

### BACKGROUND

Traditional decorative light strings often lack versatility and customization options. This invention addresses these limitations by introducing a novel decorative light string that allows users to interchange bulbs, add spur/branch lines, and adapt the configuration according to their preferences. The design also incorporates power-efficient features to connect multiple lines to a single power source and includes unique accessories for enhanced flexibility.

### SUMMARY

The present invention discloses an interchangeable decorative light string system that revolutionizes the customization, flexibility, and energy efficiency of decorative lighting solutions. In one aspect the system enables the interchange of bulbs and spur/branch lines, or the attachment of one or more spur/branch line(s) to a bulb, light string, or second spur/branch line.

The system comprises a master/main line or string that can be connected to a power source. The master/main line/string includes or is attached to sockets, accessory attachments, or sockets and accessory attachments. The sockets are configured to reversible accept a bulb or a spur/branch line with each line (master/main or spur/branch) being customizable by selection of which socket is connected with a bulb and which is connected to a spur/branch line. This interchangeability gives users creative control over lighting designs.

The spur/branch lines are connected to the master/main line through the sockets (directly connected) or through one or more spur/branch lines (indirectly connected). In certain aspects, 1, 2, 3, 4, 5, 6, 7, 8, 9, 10, 11, 12, 13, 14, 15, 16, 17, 18, 19, 20 or more spur/branch lines can be connected to one master/main line via a socket or accessory attachment (tap connector). In certain aspects, spur/branch lines are not directly connected to a power source but are connected to a power source directly or indirectly through the master/main line. A reversible socket locking mechanism ensures secure attachment and facilitates the swift interchangeability of bulbs and spur/branch lines. In certain aspects this locking mechanism is a latch mechanism. The mechanism can involve lifting a locking latch to release a bulb, inserting a spur/branch line, and clamping the locking latch to secure the spur/branch line, thereby powering the newly introduced spur/branch line. In another aspect an accessory attachment can be connected to the line or wire of a master/main line or a first spur/branch line and a second spur/branch line electrically coupled by the accessory attachment. The accessory attachment can be in the shape of an “H” or “A.” The accessory's bottom contact points can be attached to any section of the master/main line or spur/branch line, and securely clamped onto the cord forming the master/main line or spur/branch line. This accessory attachment creates a new connection point for attaching a spur/branch line without damaging or intruding on the wire it is attached to, enabling users to tailor their decorative light string configuration precisely to their preferences. In the “A” configuration, the top point also integrates the same locking mechanism as the interchangeable bulbs, simplifying the direct connection of a spur/branch line at any location along the master/main line or a second spur/branch line. The accessory attachment facilitates cost-effective customization, particularly in cases where only specific points on the master/main line require spur/branch lines, reducing overall production costs.

The Interchangeable Decorative Light String System offers a highly adaptable, energy-efficient, and cost-effective solution for customizable decorative lighting arrangements. Its innovative features empower users to create unique lighting displays while maximizing energy conservation, making it a significant advancement in the field of decorative lighting.

Certain embodiments are directed to a kit comprising an unassembled light string system. The kit may include one or more master/main lines, the master/main lines having 0, 1, 2, 3, 4, 5, 6, 7, 8, 9, 10 or more interchangeable sockets. The kit may also include 1, 2, 3, 4, 5, 6, 7, 8, 9, 10, 11, 12, 13, 14, 15, 16, 17, 18, 19, 20, or more spur/branch lines, the spur/branch lines having 0, 1, 2, 3, 4, 5, 6, 7, 8, 9, 10 or more interchangeable sockets. The kit may also include a plurality of accessory attachments, in certain aspects the kit may include 5, 10, 15, 20, 25, 30, 35, 40 or more accessory attachments. In other aspects the kit can include a power supply or an adapter/connector for connection to a power source. The kit may also include a plurality of bulbs in one more color. In certain aspects the bulbs are light emitting diodes (LED) bulbs or the like.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustrates the difference from standard (“old”) light string and one example of a light string system of the invention.

FIG. 2. Illustrates a master/main line string with a connector to a power source.

FIG. 3. Architecture for adding a spur/branch light string.

FIG. 4. Illustration of one example of an accessory attachment.

FIG. 5. Illustration of bottom socket connector.

FIG. 6. Illustration of over-bulb connector.

FIG. 7. Illustration of 90 degree connector.

### DESCRIPTION

The following discussion is directed to various embodiments of the invention. The term “invention” is not intended to refer to any specific embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

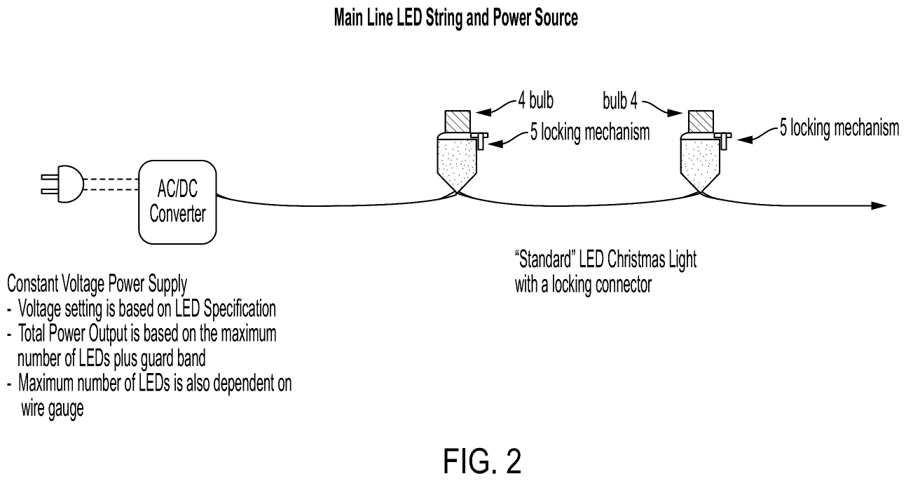

Master/main Line or master/main string: This is the primary component of the light string, which can be connected to a power source (see FIG. 2 for an example). The master/main line can be designed with different variations in number and spacing of sockets and/or bulb sockets. In certain aspects the wire or chord of the master/main line is compatible with tap connectors.

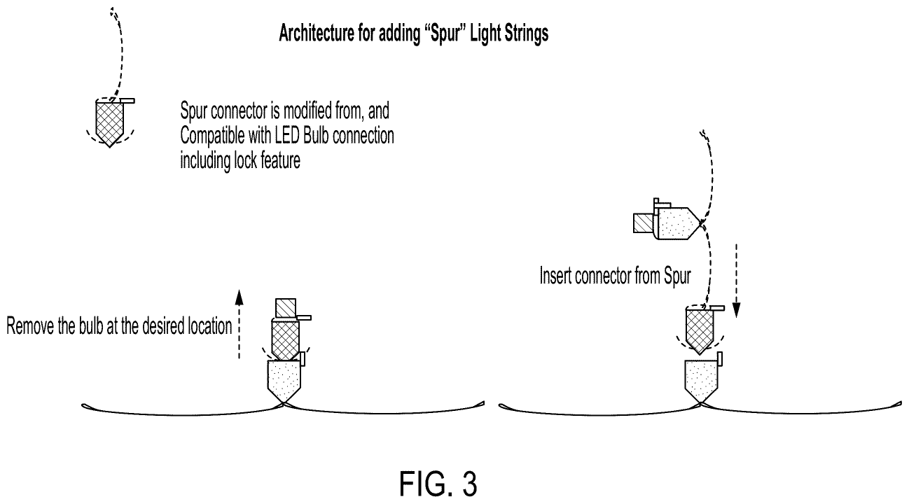

Spur/branch Lines or spur/branch string: These are secondary lines that typically do not have a direct power source but are designed to connect to the master/main line directly or indirectly at the points where interchangeable bulbs or accessory attachments are located. Spur/branch lines can be added or removed as needed for customization. The spur/branch lines have a spur/branch line connector configured to interact with and connect to a socket in the master/main line or a second spur/branch line, or an accessory attachment. The spur/branch connector is inserted in an empty socket-connecting the spur/branch line with the master/main line or another spur/branch line (see FIG. 3).

Sockets: Each socket on the master/main line or a spur/branch line can have a locking mechanism for easy removal and replacement of a bulb or a spur/branch line. A locking latch can secure the bulb or spur/branch line in place while allowing for swift interchangeability.

There are a number of bulb types that can be used, including but not limited to screw bases, fluorescent pin bases, twist and lock bases, BI pin bases, bayonet bases, wedge bases, compact fluorescent plug in bases, miniature bases, and specialty bases. Screw bases can include but are not limited to a miniature screw (E10), miniature candelabra (E11), candelabra (E12), European (E14), intermediate (E17) medium (E26), or mogul (E39) base. Fluorescent pin bases can include but are not limited to miniature bipin, medium bipin, single pin, recessed double contact, 4-pin, or 2GX-13 base. Twist and lock bases can include but are not limited to GU10 or GU24 base. BI pin bases can include but are not limited to G4, GU4, G5.3, G5, GU5.3, GX5.3, GY5.3, G6.35, GY6.35, GZ6.35, GY8, G8.5, G9, G9 pin blade, G9.5, GX9.5, GZ9.5, and G12 baes. Bayonet bases can include but are not limited to miniature bayonet, double contact bayonet, single contact bayonet, and index double contact bayonet base. Wedge bases can include but are not limited to wedge, wedge D.F., wedge S.F., RX7s, slide, and wedge subminiature bases. Compact fluorescent plug in bases can include but are not limited to 2G7, 2GX-7, 2G11, G23, G24d-2, G24d-3, G24q-1, G24q-2, G24q-3, GX23, GX23-2, GX24q-1, GX24q-2, GX24q-3, GX24q-4, and GX24q-5 base. Miniature bases can include but are not limited to refocus, right angle prefocus, axial prefocus, straight, midget flanged single contact, miniature flanged single contact, miniature single contact, P28S, P32d2, P43T, P43T-38, PK22s, and Px26d base. Specialty bases can include but are not limited to festoon, 3 contact lugs, multipurpose screw terminal, mogul end prong, PGJ5, metal clip, rigid loop, side prong, and lead wires base. The socket for each base is configured to accept and reversibly lock the selected base type in position during use. The base type can be included or configured at the terminus of or within a spur/branch string for reversible positioning within a second string.

In certain aspects the bulb is a light emitting diode (LED). Light-emitting diodes (LEDs) come in various types, each designed for specific applications and optimized for different characteristics. Some common types of LEDs include: Red LEDs: Emit red light and are one of the earliest and most common types of LEDs. Green LEDs: Emit green light and are also widely used. Blue LEDs: Emit blue light and are crucial for creating white light in combination with phosphors. White LEDs: Typically created by using blue LEDs with a phosphor coating or by combining red, green, and blue LEDs. They are versatile and used in various applications, including general lighting. RGB LEDs: Contain red, green, and blue LED chips in a single package, allowing for a wide range of colors by mixing different intensities of these colors. Organic LEDs (OLEDs) use organic materials to emit light. Quantum Dot LEDs (QLEDs) utilize quantum dots to enhance color accuracy and brightness. MicroLEDs consist of tiny individual LEDs, typically less than 100 micrometers in size.

LED by Special Features: Smart LEDs are equipped with wireless communication capabilities, these LEDs can be controlled remotely, often used in smart lighting systems. High-Efficiency LEDs are designed for maximum energy efficiency and long life spans.

Operation Controller: Controlling light strings has evolved with technology, offering various methods tailored to different needs and levels of complexity. In certain aspects a control mechanism is coupled proximally where the entire string is under control of a single controller or individual controllers are couple to various main lines or spur/branch lines to control various components of the light assembly individually. The most basic method involves plug-in controllers where lights can be plug into a controller that is then plugged into the power source. Other controller are remote controls using IR or RF technology, these allow users to change settings from a distance, including color, brightness, and patterns. Wi-Fi and Smart Controls can be integrated with smart home systems like Alexa, Google Home, or dedicated apps, these lights can be controlled via voice commands or smartphones, offering features like scheduling, custom light shows, and even synchronization with music. For professional setups, DMX (Digital Multiplex) controllers provide precise control over individual lights or sections, commonly used in stage lighting to create complex visual effects. Bluetooth Controls are similar to Wi-Fi but often with a shorter range, Bluetooth enables control through paired devices, which is useful for more localized adjustments without needing an internet connection. Each method offers different levels of convenience, customization, and automation, catering to everything from simple home decorations to elaborate professional displays.

Programming light can be approached in various ways depending on the technology used, the purpose, and the level of control desired. Methods of programming include, but are not limited to (i) LED Programming: (a) Microcontrollers: Using platforms like Arduino, Raspberry Pi, or ESP32, you can program LEDs to change color, brightness, or pattern based on code. For example, you might use PWM (Pulse Width Modulation) to control brightness or RGB values for color. (b) Firmware: Some LEDs come with embedded firmware that can be updated to change behavior, like Philips Hue bulbs. (c) Addressable LEDs (e.g., NeoPixel): Each LED can be individually controlled, allowing for complex patterns and animations. (ii) DMX Control used in stage lighting, DMX allows for detailed control over individual lights or groups of lights, programming everything from color to movement. (iii) Smart Home Systems: (a) Integration with Hubs: Lights can be programmed via smart home systems like HomeKit, Google Home, or Amazon Alexa. Routines can be set up to turn lights on/off, change colors, or dim at specific times or in response to events. (ii) IoT Devices: Devices like smart bulbs can be programmed using APIs or direct control interfaces provided by manufacturers. (iv) Software and Apps: (a) Mobile Apps: Many lighting solutions come with apps where you can create schedules, scenes, or even respond to music or other environmental inputs. (b) PC Software: More advanced setups might use software like Vixen Lights or xLights for elaborate synchronized light displays, often used for holidays. (v) Automated Systems: (a) Time-Based Automation: Lights can be programmed to change based on time of day, simulating sunrise/sunset or turning on/off at set times. (b) Sensor-Based: Integration with sensors for motion, light, or presence can trigger light changes. For example, lights turning on when someone enters a room. (vi) Dynamic Lighting Effects: (a) Music Visualization: Programming lights to react in real-time to music, often used in clubs or home entertainment systems. (b) Weather Responsive: Some systems can adjust lighting based on weather conditions or forecasts. (vii) Art Installations and Interactive Displays: Custom Code can be used for art projects, custom scripts might be written in languages like Processing or Max/MSP to create interactive or responsive light installations. (viii) Industrial and Architectural Lighting: Building Management Systems (BMS) can be integrated with HVAC and security systems, lights can be programmed for efficiency, emergency responses, or to enhance architectural features. (ix) Scripting and Macros: Scripting Languages can be employed for more advanced setups, Python or JavaScript might be used to script lighting behaviors, especially in environments where lights are part of a larger system or performance. (x) AI and Machine Learning: Adaptive Lighting can use artificial intelligence (AI) to predict and adjust lighting based on user habits, mood, or productivity needs.

In certain aspects the lighting is Zigbee lighting which refers to a type of smart lighting system that uses the Zigbee wireless communication protocol to operate. Zigbee is a wireless protocol designed for home automation and IoT devices. It operates on the IEEE 802.15.4 standard, known for its low power consumption, reliability, and mesh networking capabilities. Key Features of Zigbee Lighting include (i) Low Power Consumption, Zigbee devices are designed to be energy-efficient, allowing lights to run on battery power for extended periods or reduce energy usage when connected to mains power, (ii) Mesh Networking, unlike Wi-Fi or Bluetooth, Zigbee uses mesh networking where each device can act as a repeater, extending the range and reliability of the network. If one device fails, others can still communicate by finding alternative paths through the mesh, (iii) Interoperability, many Zigbee lighting products are certified under Zigbee Alliance standards like Zigbee 3.0 or Zigbee Light Link, ensuring different brands of lights and controllers can work together seamlessly.

Zigbee provides various control options, such as: (i) dimmers for adjusting the brightness of the lights, (ii) color temperature adjustment allowing the changing of the color temperature from warm (reddish) to cool (bluish) white, (iii) RGB Lights offering full-color spectrum control, allowing for any color to be displayed.

Zigbee lights can be integrated with smart home systems like Amazon Alexa®, Google Home, or hubs like Philips Hue®, Samsung SmartThings®, or Hubitat®. This allows for voice control, scheduling, and automation scenarios (e.g., lights turn on at sunset).

A lighting system can start with a few lights and be easily expanded. The mesh network means the more devices you add, the stronger your network can become. Zigbee implements several layers of security, including encryption for data transmission, ensuring that your lighting controls are secure from unauthorized access.

Temperature or Kelvin temperature, in the context of lighting, refers to the color temperature of a light source, which is a measure of its light appearance, specifically its warmth or coolness. Color temperature is measured in Kelvin (K). Unlike the Celsius or Fahrenheit scales, higher Kelvin values indicate cooler (bluer) light, while lower Kelvin values indicate warmer (yellower) light.

Warm Light is 2700K-3000K. This range is considered warm white. It mimics the glow of a traditional incandescent bulb, giving off a yellowish, cozy feel. This type of lighting is often used in homes for living rooms, bedrooms, or dining areas to create a welcoming, relaxed atmosphere.

Neutral Light is 3500K-4500K. This is a neutral white light, which appears more clinical or office-like. It provides a balanced light that's neither too warm nor too cool. Often used in retail environments or as general lighting where a neutral color rendering is desired without leaning too much towards warm or cool tones.

Cool Light is 5000K-6500K. This range is considered cool white or daylight. It simulates natural daylight and has a bluish tint. This type of light is often used in task lighting, such as in workshops or reading lamps, where clarity and detail are important. It is also common in commercial settings where a bright, energizing atmosphere is desired.

Very cool light is above 6500K. Very cool, almost blue light, which can mimic a cloudy sky or overcast day. This is less common in residential settings but might be used in specialized applications like photography or certain types of retail displays to make products look more vibrant.

Modern LED lights can offer a wide range of color temperatures. Some advanced LED systems even allow users to adjust the color temperature, providing flexibility in setting the mood or function of a room. Warm light can make environments feel more intimate and comfortable, enhancing reds and yellows. Cool light can make an environment feel more alert, enhancing blues and greens, which is why it's often used in environments where focus and productivity are key. Understanding Kelvin temperature helps in choosing the right lighting for different purposes, whether it's for aesthetics, functional needs, or both. It's not just about the brightness of light but also about how that light makes objects and spaces look and feel.

Accessory attachment (H-shaped or A-shaped): The accessory attachment is an additional component that enhances the flexibility of the light string. It comes in the shape of an “H” or “A” and can be attached to any part of the master/main line. The bottom contact points of the accessory attachment can be clamped onto or otherwise connected to the cord of the master/main line or spur/branch line to create a new connection point, providing an electrical coupling. The accessory attachments allow connection to an insulated wire without requiring stripping of the insulation. This connection connects the end of one line or string to the middle of a second line or string. The identity of these connectors can be a male or a female; there is no specific type. Besides, the standard can be different; for example, F type, BNC, or N-type can be part of the connection. In certain aspects the connection is a non-invasive connection that maintains the integrity of the line or string receiving the accessory attachment. This is particularly useful when only specific points on the master/main line need to support a spur/branch line. In certain aspects, a low voltage T tap connector can be used (e.g., a 2 Pin, solder-less Rock-Solid Connector). In certain aspects the accessory attachment is configured so there is no need to peel the wire or break the wire jacket. In certain aspects the accessory attachment is suitable for 20/22 AWG electrical wire connection. The accessory attachment can but is not limited to working voltage of 12V-24V DC, 300V AC with a working current of 0-10 A.

Strings can be connected or coupled directly by wire to wire contact or by non-contact electrical coupling, which refers to methods of transferring electrical energy or signals without direct physical or metallic contact between the source and the receiver. Types and principles behind non-contact electrical coupling include but are not limited to 1. Inductive coupling utilizes the principles of electromagnetic induction where a changing magnetic field through a coil induces a voltage in another nearby coil. Used in transformers, wireless charging pads for devices like smartphones, and RFID (Radio Frequency Identification) technology. For example a coil creates an alternating magnetic field, which induces a current in another coil. 2. Capacitive coupling involves the transfer of an alternating electric field between two conductors separated by a dielectric medium. This creates a kind of capacitor where charge is stored on one side and then transferred to the other through the electric field. This coupling is found in touchscreens where a change in capacitance due to a touch is detected, and in some types of signal coupling to transfer data or power across an isolating barrier. Capacitors in electronic circuits can couple AC signals while blocking DC, allowing signal transfer without direct connection. 3. Electromagnetic coupling involves the use of electromagnetic waves to transfer energy or information. This is broader than inductive coupling as it doesn't necessarily require coils but can use any form of electromagnetic radiation. Wi-Fi, Bluetooth, and other wireless communication technologies where data (and sometimes power in RF energy harvesting) are transmitted through the air. 4. Optical Coupling (Opto-isolation) uses light to transfer a signal between elements of a circuit. An LED emits light which is detected by a photodiode or phototransistor, converting the light signal back into an electrical signal. 5. Magnetic Coupling is similar to inductive coupling, magnetic coupling might specifically refer to systems where magnetic fields alone (without necessarily inducing voltage in a traditional sense) are used for coupling. This could include magnetic gears or couplings where torque is transferred through a magnetic field.

The design of the decorative light string allows for the connection of multiple lines to a single or multiple power source(s). This feature enhances energy efficiency and reduces the number of power sources needed, making the light string environmentally friendly and cost-effective.

The flexibility and versatility of the light strings described herein can be used in a number of context. (i) Event Decor: Easily customize lighting layouts for weddings, parties, and festivals by plugging in additional lights as needed. (ii) Theater and Stage Lighting: Modify and extend lighting setups quickly for different shows or performances without rewiring. (iii) Gardening and Landscaping: Flexibly light up garden paths, flower beds, and outdoor features by adding or rearranging lights in desired locations. (iv) Interior Design: Customizable lighting for homes, allowing homeowners to easily add or adjust lights in rooms, shelves, and furniture. (v) Retail Displays: Rapidly change and enhance store displays with adaptable lighting configurations for showcasing products. (vi) Photo and Video Production: Quick adjustments to lighting arrangements on sets for different scenes and shots. (vii) Holiday Decor Beyond Christmas: Adaptable lighting setups for various holidays and celebrations, like Halloween, Easter, or Independence Day. (viii) Public Spaces and Parks: Flexible lighting solutions for nighttime events or seasonal decorations in parks and public areas. (ix) Exhibits and Museums: Dynamic lighting installations to highlight exhibits, with easy changes for new displays. (x) Emergency Lighting: Rapid deployment and adjustment of lights for emergency or temporary shelters. (xi) Smart Homes: Integration with smart home systems, allowing for adaptable and customizable home lighting controlled via apps. (xii) Architectural Lighting: Highlighting building features with flexible light placement, making it easier to adjust lighting for different architectural designs. Users can easily customize their decorative light string by interchanging bulbs for spur/branch lines or adding a bulb and removing a spur/branch line.

The ability to connect multiple lines to a single power source promotes energy efficiency. The accessory attachment provides flexibility in choosing connection points for spur/branch lines. By allowing only specific points on the master/main line to support spur/branch lines, the accessory attachment reduces the cost of goods.

Ingress Protection (IP) ratings for lighting, or any electrical equipment, indicate the level of protection against intrusion, mainly by foreign bodies like dust and moisture. The IP codes typically relevant for lighting and what they signify include the following: (i) First Digit (Protection against solids): 0—No protection, 1—Protection against objects greater than 50 mm, like hands, 2—Protection against objects greater than 12.5 mm, like fingers, 3—Protection against objects greater than 2.5 mm, like tools, wires, etc., 4—Protection against objects greater than 1 mm, like most wires, 5—Dust-protected. Limited ingress of dust is allowed, but it won't interfere with the operation of the equipment, 6—Dust-tight, no ingress of dust; (ii) Second Digit (Protection against liquids): 0—No protection, 1—Protection against vertically falling drops of water, like condensation, 2—Protection against direct sprays of water up to 15° from vertical, 3—Protection against sprays up to 60° from vertical, 4—Protection against water splashed from any direction, 5—Protection against low-pressure water jets from any direction, 6—Protection against strong jets of water (e.g., for use on ship decks), 7—Protection against the effects of immersion between 15 cm and 1 m, 8—Protection against long periods of immersion under pressure. Common IP ratings include IP20 (basic protection against access to hazardous parts by hands, no protection against water), IP44 (commonly used for indoor lighting, protects against objects larger than 1 mm and water splashed from any direction), IP54 (often seen in outdoor lighting, adds dust protection to the above), IP65 (suitable for outdoor or harsh environments, offering full dust protection and resistance to water jets), IP66 (similar to IP65 but with better resistance to water jets, suitable for more extreme conditions), and IP67/IP68 (used in underwater lighting or fixtures that might be submerged, like in swimming pool lights or very harsh industrial environments). When choosing lighting, consider the environment where the fixture will be installed to ensure it has an appropriate IP rating. For instance, outdoor or wet areas like bathrooms would need higher water ingress protection, while indoor office lighting might only need basic protection against solid objects.

In certain embodiments the light string can have a particular Ingress Protection (IP) rating, such as a IP65 rating. This rating is used to characterize lighting, particularly for outdoor or industrial applications, because it provides specific protection against environmental factors. Ingress Protection (IP) code characterizes the protection against dust, and protection against water. The appropriate rating provides that the lights have a durability and safety and is essential for ensuring that lights used outdoors or in challenging environments remain safe, reliable, and functional over time. An IP65 rating for lighting indicates the level of protection the lighting fixture provides against the ingress of dust and water. In a rating of IP65 the first digit (6) means the lighting is totally protected against dust. This means no ingress of dust is allowed, providing a very high level of protection against solid particles. The second digit (5) indicates that the lighting can withstand water projected from a nozzle against the enclosure from any direction. This protection level is suitable for exposure to low-pressure jets of water from any direction, which might be encountered in outdoor conditions where rain or water jets might be present.

An IP65 rating ensures the fixture can handle dusty or very humid conditions without failing due to dust accumulation or water ingress and is suitable for a variety of outdoor applications, like garden lights, pathway lights, or any external architectural lighting where weather exposure is expected but not extreme water submersion or high-pressure cleaning. When considering lighting for specific environments, especially outdoors or in areas with potential water exposure, an IP65 rated light would be a reliable choice for ensuring longevity and performance under adverse conditions. For environments where more severe water exposure is expected (like continuous submersion or high-pressure washdown), a higher rating like IP67, IP68, or even IP69K may be needed for the most rigorous conditions involving high-temperature water jets or steam cleaning. In certain aspects a light string can have a IP rating of IP20, IP44, IP54, IP65, IP66, IP67, or IP68.

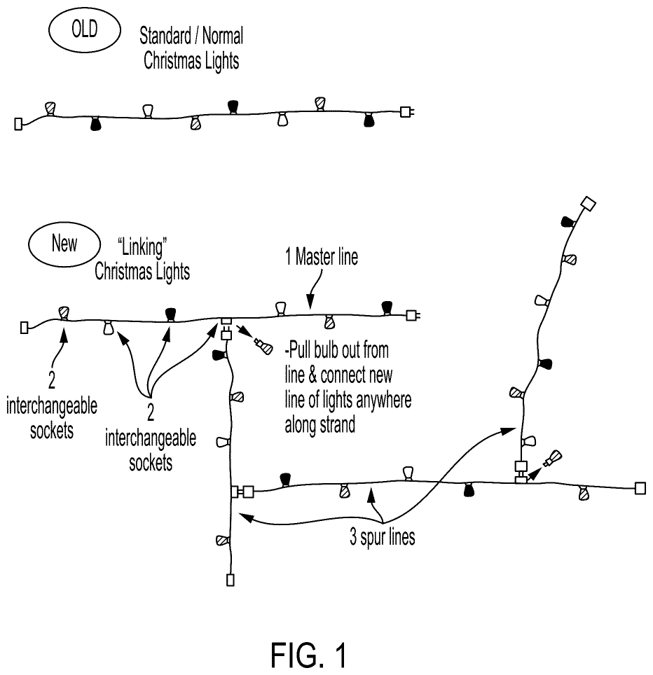

FIG. 1 illustrates the distinction between a standard light string and an assembled decorative light string of the invention. A standard light string has a single master/main line. A decorative light string of the invention has master/main line 1 containing at least one interchangeable socket 2. If a bulb is present in a particular interchangeable socket it can be removed and a spur/branch line 3 can be put in its place. Spur/branch line 3 can in turn have one or more interchangeable sockets 2 which can be connected to a second, third, or more spur/branch lines 3. In certain aspects a bulb is a light emitting diode (LED).

FIG. 2 illustrates the general design of the master/main line with interchangeable sockets having bulb 4 installed and locking mechanism 5 retaining the bulb in the socket. Release of locking mechanism 5 allows a user to remove bulb 4 and insert and lock spur/branch line 3 in place of the bulb, interchanging bulb and spur/branch line. In certain aspects the locking mechanism is a socket and stud mechanism, push pin socket, push and press to release, latch and catch, or other reversible locking mechanisms. In certain aspects one wants to secure a light bulb or spur/branch line or string in a socket to prevent accidental disconnect. A few mechanisms that can be used for this purpose include but are not limited to (i) Sockets can be designed with locking mechanisms built-in (e.g., latch and peg). These sockets can require a key or tool to insert or remove the bulb or spur/branch line. (ii) adhesive or threadlocker to lock a light bulb in a socket-a non-permanent adhesive or threadlocker is applied to a socket before connecting a bulb or spur/branch line or string it into the socket. (iii) Wire or Cable Lock can be use to physically secure a light bulb or spur/branch line or string to the socket. This involves attaching a flexible wire or cable to the base of the bulb and then looping it around the fixture or socket in a way that prevents easy removal. A small lock can be used to secure the wire or cable in place. (iv) Security screws or fasteners that require unique tools to remove can be place on the socket. (v) Gravitational locks rely on the orientation of the bulb and socket to keep the bulb in place. When the bulb or spur/branch line is correctly oriented, it locks in, and turning it in the wrong direction will not disconnect the bulb or spur/branch line.

FIG. 3 illustrates a mechanism for adding a spur/branch line. The spur/branch line has a connector that is compatible with a socket of a master/main line or second spur/branch line. In certain aspects a bulb is removed forming an empty socket. The spur/branch line connector is inserted in the empty socket. In certain aspects the spur/branch line connector is locked in place or otherwise secured.

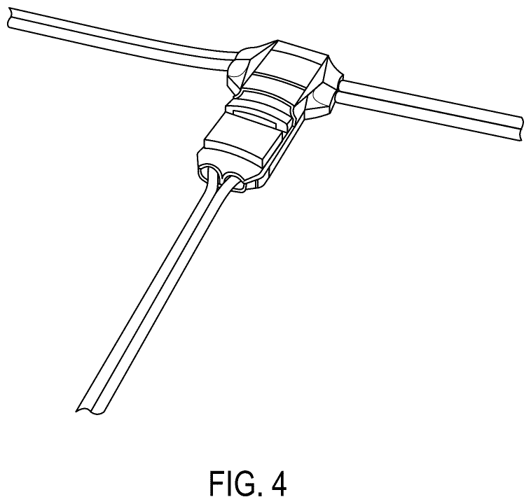

FIG. 4 illustrates an example of a tap connector. This particular tap connector is a T tap connector due to the T shape formed when the tap connector is engaged with a second wire. Various configurations of a tap connector are contemplated including (i) an A type having the wire engaging component at the apex of the A and a spur/branch line connected at the base, or (ii) an H type having one end (proximal end) configured to clamp a host wire or line and the other end (distal end) configured to connect a spur/branch line.

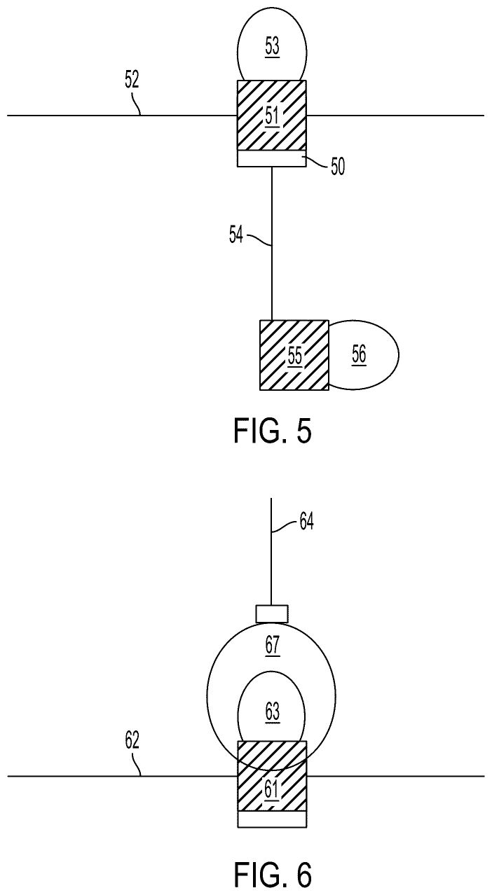

FIG. 5 illustrates bottom connector 50 operatively coupled to a first light socket 51 on a first light string 52 having a first bulb 53. Connector 50 being connected to second light string 54 having at least a second light socket 55 and a second bulb 56.

FIG. 6. Illustrates an over-the bulb connector 67 operatively coupled to a first light socket 61 on a first light string 62 having a first bulb 63. Connector 67 being connected to second light string 64 having at least a second light socket and a second bulb.

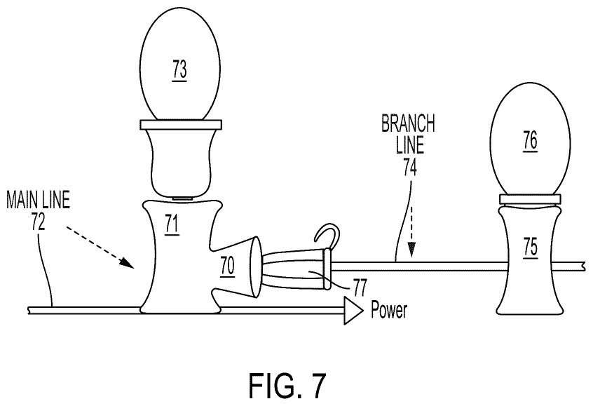

FIG. 7. Illustration of 90 degree connector operatively coupled to a first light socket 71 on a first light string 72 having a first bulb 73. Connector 70 being connected to second light string 74 having at least a second light socket 75 and a second bulb 76 and a spur/branch line connector 77. Connector 70 can be positioned at any radial angle parallel to main line 72 and/or at any angle relative to the plane of main line 72.

Connectors can be in various configurations and multiple connectors can be used within a particular light string assembly. For connecting light strings, especially in the context of present invention, there are several types of connectors and methods that can be used. End-to-End Connectors having male-to-female Plugs are simple connectors where one string of lights ends in a male plug that can fit into the female socket of another string. Male splitters are male plugs that split into multiple female sockets, allowing you to connect several strings from one outlet or another string. Quick connectors can be used for LED light strips where you push the wire into a connector without needing to strip or twist any wires. Adapters are described that can be used if you need to extend or connect strings where you might have for example two male or two female ends, or desire to connect to a string at a position that does not have a connector. Clip connector or alligator clips can be used where you might need to quickly connect or disconnect lights without permanent fixtures.

Connectors or accessories can have various configurations and attachment mechanisms. A bulb can have a bottom connector where a connecting mechanism is provided in the base of a bulb socket, see FIG. 5. Another configuration is an over-the-bulb connector where a clamp, cover, or sheath is placed over a bulb and connects to the top of bulb socket, see FIG. 6. In one aspect a socket or accessory has a reversible socket locking mechanism ensures secure attachment and facilitates the swift interchangeability of bulbs and spur/branch lines. In other aspects the socket or accessory can have a click-in mechanism or a screw or turn mechanism such as a quarter turn mechanism. In certain aspects this locking mechanism is a latch mechanism. The mechanism can involve lifting a locking latch to release a bulb, inserting a spur/branch line, and clamping the locking latch to secure the spur/branch line, thereby powering the newly introduced spur/branch line. In another aspect an accessory attachment can be connected to the line or wire of a master/main line or a first spur/branch line and a second spur/branch line electrically coupled by the accessory attachment. The accessory attachment can be in the shape of an “H” or “A.” The accessory's bottom contact points can be attached to any section of the master/main line or spur/branch line, and securely clamped onto the cord forming the master/main line or spur/branch line. This accessory attachment creates a new connection point for attaching a spur/branch line without damaging or intruding on the wire it is attached to, enabling users to tailor their decorative light string configuration precisely to their preferences. In the “A” configuration, the top point also integrates the same locking mechanism as the interchangeable bulbs, simplifying the direct connection of a spur/branch line at any location along the master/main line or a second spur/branch line. The accessory attachment facilitates cost-effective customization, particularly in cases where only specific points on the master/main line require spur/branch lines, reducing overall production costs.

1. A decorative light string comprising:
(i) a main line configured to connect with a power source;
(ii) a plurality of sockets distributed along the main line;
(iii) one or more branch lines having a plurality of sockets distributed along the branch line, the branch line configured with a branch line connector to connect with the main line or a second branch line by being electrically coupled to the main line or the second branch line;
the sockets are configured to receive either a bulb or a branch line, the socket comprising a locking mechanism for reversibly attaching and securing a bulb, or reversibly attaching and securing a branch line.

2. The decorative light string of claim 1, further comprising an accessory attachment configured to non-invasively connect a branch line to the main line or second branch line.

3. The decorative light string of claim 1, wherein the sockets are configured to connect a branch line.

4. The decorative light string of claim 1, further comprising a power source.

5. The decorative light string of claim 4, wherein the power source can power a plurality of LED lines simultaneously.

6. The decorative light string of claim 1, wherein the main line has 1, 5, 10, 20, 30 or more sockets.

7. The decorative light string of claim 1, wherein the branch line has 1, 5, 10, 20, 30, or more sockets.

8. The decorative light string of claim 1, wherein the main line is connected to 1, 2, 3, 4, 5, or more branch lines either directly by a socket or indirectly by an accessory attachment.

9. The decorative light string of claim 1, wherein the locking mechanism has two contact points designed to attach to the main line and secure or clamp the socket onto the main line.

10. The decorative light string of claim 1, wherein the light string or system is configured to provide warm light, neutral light, or cool light.

11. The decorative light string of claim 1, wherein the light string or system is configured to provide light at a light temperature of 2700K to 6500K.

12. The decorative light string of claim 1, wherein the light string has an ingress protection rating of IP20, IP44, IP54, IP65, IP66, IP67, or IP68.

13. The decorative light string of claim 1, further comprising a control system, in particular a Zigbee control system.

14. An accessory attachment having a proximal end configured to attach to a main line or branch line and a distal end configured to connect to a branch line connector.

15. The accessory of claim 11, wherein the accessory is shaped in the form of an “H,” with the proximal end forming a clamp to interact with the master/main line.
